(19) United States
(12) Patent Application Publication
(10) Pub. No.: US 2026/0161897 A1
(43) Pub. Date: Jun. 11, 2026

(54) COMPLEX INSTRUCTION-BASED TRAINING INSTANCES TO FINE TUNE LLM

(71) Applicant: GOOGLE LLC, Mountain View, CA (US)

(72) Inventors: Rajiv Mathews, Sunnyvale, CA (US); Mingqing Chen, Saratoga, CA (US); Qi Ge, Fremont, CA (US); Swaroop Indra Ramaswamy, Belmont, CA (US); Andrew Hard, Menlo Park, CA (US); Kilol Gupta, Redwood City, CA (US); Beck Chen, Mountain View, CA (US)

(21) Appl. No.: 19/407,992

(22) Filed: Dec. 3, 2025

Related U.S. Application Data
(60) Provisional application No. 63/728,456, filed on Dec. 5, 2024.

(51) Int. Cl. G06F 40/35; G06F 16/3329

(52) U.S. Cl. CPC G06F 40/35; G06F 16/3329

(57) ABSTRACT

Implementations relate to fine-tuning a generative model using training instances that phrase task(s) as instruction(s), and subsequently utilizing the fine-tuned generative model to respond to user input(s). The training instances can include a first training instance. The first training instance can include a first training instance input that includes a formulated user input, side information that provides information to generate a response to the formulated user input, and a complex instruction. The complex instruction is a multi-part instruction including a first description that instructs to respond utilizing side information and a second description that instructs to only use inherent knowledge to respond when the side information provides no useful information for responding. The first training instance can further include a first ground truth response derived from the side information responsive to the formulated user input.

### BACKGROUND

Large language models (LLMs) are neural networks with applications in various domains and fields. An LLM is often a transformer-based model, pre-trained using a large corpus of unlabeled raw text (e.g., authorized books, online text, etc.), to acquire knowledge that spans diverse subjects. The pre-trained LLM thus possesses the capability of generating LLM output that reflects generative natural language (NL) content and/or other generative content, in response to a natural language user query and/or other user input(s). For instance, the pre-trained LLM can be used to process a user input of “how to change DNS settings on Acme router”, to generate LLM output that reflects several responsive NL sentences such as: “First, type the router's IP address in a browser, the default IP address is 192.168.1.1. Then enter user name and password, the defaults are admin and admin. Finally, select the advanced settings tab and find the DNS settings section”.

However, it is recognized that pre-training the LLM can require a significant quantity (e.g., millions) of training instances to acquire inherent knowledge. Due to the significant quantity of training instances needed, many training instances may lack input and/or output properties that are desired when the LLM is deployed for utilization. For example, some training instance inputs for an LLM can lack desired contextual data (e.g., user attribute(s) associated with the input, conversational history associated with the input, side information available on a device, etc). As a result, such pre-trained LLM, when deployed, may generate many instances of output that likewise lack the desired output properties and/or can possess no capability in utilizing contextual data or other available information to provide desired output.

### SUMMARY

Various implementations disclosed herein relate to fine tuning a generative model (e.g., a pre-trained LLM) using training instances that phrase downstream task(s) as instruction(s), and subsequently utilizing the fine-tuned generative model (e.g., fine-tuned LLM) to respond to user input(s). The downstream task(s) can sometimes be referred to as “task(s)”. As a non-limiting example, the downstream task(s) can include a task of question-answering. The instruction that is for the task of question-answering and that is included in one or more of the training instances can be a multi-part instruction. In this non-limiting example, the multi-part instruction can include natural language content that instructs the pre-trained LLM to leverage inherent knowledge of the fine-tuned generative model or to leverage side information that is in addition to the inherent knowledge, in performing the task of question-answering.

In the above non-limiting example, the side information can include, for instance, one or more search results available at, or accessible via, a client device that implements the pre-trained LLM (during fine-tuning) or the fine-tuned LLM (during inference). The one or more search results can be, for instance, generated based on user searches/queries and be stored in one or more search result documents. The one or more search results can be stored in a search result database locally. The one or more search result documents, for instance, can each include a distinct search result acquired based on a search of a distinct entity (e.g., object, event, location, celebrity, etc.). Alternatively, the one or more search result documents can each include a distinct set of search results responsive to a distinct entity. It is noted that descriptions of the one or more search results and/or the search result documents are limited herein. It is further noted that the side information can include other data instead of, or in addition to, the one or more search results, and the present disclosure is not limited herein.

Optionally, instructions included in different training instances can be the same. For instance, an instruction included in a training instance to fine-tune the pre-trained LLM in performing a first downstream task can be the same as an instruction included in an additional training instance also to fine-tune the pre-trained LLM in performing the first downstream task. Optionally, instructions included in different training instances can be different. For instance, the instruction included in the training instance to fine-tune the pre-trained LLM in performing the first downstream task can be different from an instruction included in a further training instance that is to fine-tune the pre-trained LLM in performing a second downstream task. The second downstream task can be different from the first downstream task.

In various implementations, a plurality of training instances for fine tuning the pre-trained LLM are curated/generated. The pre-trained LLM, for instance, can be pre-trained using a large quantity (e.g., millions or tens of millions) of training instances. Such pre-trained LLM can be fine-tuned, for instance, in a supervised manner using the plurality of training instances, to enable the fine-tuned LLM in determining whether or not to leverage side information (that is in addition to its own inherent knowledge), in performing a downstream task determined based on user input.

In some implementations, the plurality of training instances to fine-tune the pre-trained LLM can each include a training instance input and a ground truth response. The training instance input can be formulated to include a user input, side information associated with the user input, and/or a complex instruction. Optionally, the user input in the training instance input can be formulated manually. The complex instruction can be a multi-part instruction that instructs the pre-trained LLM to use the side information to respond to user input and that instructs the pre-trained LLM to use inherent knowledge to respond to the user input only if the side information is not useful in responding.

As a working example, the plurality of training instances to fine-tune the pre-trained LLM can include a first training instance and/or a second training instance. The first and second training instances can be utilized to fine-tune the pre-trained LLM in performing a first task. The first training instance to fine-tune the pre-trained LLM in performing the first task can include a first training instance input and a first ground truth response.

Continuing with the working example above, the first training instance input for fine-tuning the pre-trained LLM in performing the first task can include: first user input, first side information associated with the first user input, and a first complex instruction. The first user input in the first training instance can include a first user query, and the first side information can include a first set of search results providing an answer to the first user query. The first complex instruction can be a multi-part instruction. For instance, the first complex instruction can be a two-part instruction including: a first portion that instructs the pre-trained LLM to use search result(s) to generate a response responsive to the user query; and a second portion that instructs the pre-trained LLM to use inherent knowledge to generate the response if and only if the search result(s) are not useful in generating the response. Optionally, the first set of search results included in the first training instance input can be retrieved from a search result database, based on searching the search result database using the user query (or one or more keywords from the user query). For instance, the first set of search results can be determined/retrieved based on identifying search result(s) from the search result database that are responsive to an entity identified in the first user query and based on confirming that the identified responsive search result(s) include at least one search result that provides useful information to respond to the first user query.

For instance, the first user query in the first training instance input can be, “Where was President Obama born?” The first set of search results can include a first search result, such as “With a father from Kenya and a mother from Kansas, President Obama was born in Hawaii on Aug. 4, 1961. He was raised with help from his grandfather . . . ” The first set of search results can include a second search result, such as “The nation's 44^{th} president was born on this day in 1961 in Honolulu, two years after the territory was admitted to the union . . . ” The first complex instruction can be, for instance, “use the aforementioned search results to provide your response. If you are unable to use the search results to provide an answer, only then should you use your inherent knowledge to provide an answer”. In this case, the first ground truth response of the first training instance can be “Honolulu, Hawaii”, which is an answer (to the user query) extracted from the first search result that is responsive to the user query of “Where was President Obama born?”.

Continuing with the working example above, the second training instance for fine-tuning the pre-trained LLM in performing the first task can include: second user input, second side information associated with the second user input, and a second complex instruction. Optionally, the second user input can be formulated prior to, approximately at the same time, or subsequent to, formulation of the second side information. Optionally, the second complex instruction can be the same as the first complex instruction. The second user input in the second training instance can be formulated to include a second user query that is different from the first user query. In some implementations, the second user query can be formulated so that the second side information (e.g., a second set of search results) provides no useful information for generating a response (e.g., an answer) to the second user query.

In some implementations, optionally, the second set of search results can be selected the same as the first set of search results. In this case, optionally, the second user query can be formulated based on first set of search results and based on the second user query. For instance, the second user query can be formulated to be directed to an entity that the first set of search results are responsive to, while being formulated to ensure that the first set of search results provide no useful information to generate a response to the second user query.

Optionally, the second set of search results can be different from the first set of search results. For instance, the second side information can include a second set of search results that partially overlap (or do not overlap) with the first set of search results. In this case, the second user query can be formulated to be directed to the same entity as the first user query, or the second user query and the first user query can be directed to different entities. In implementations where the second user query is formulated to be different from the first user query, the second set of search results can be identified based on the second user query. For instance, the second set of search results can be determined based on identifying search result(s) from a search result database that are responsive to an entity in the second user query and based on removing any search result that provides useful information for the second user query from the identified responsive search result(s).

For instance, the second user query in the second training instance input can be, for instance, “What state was Obama a senator for?” The second side information (e.g., the second set of search results) can include the aforementioned first search result, such as “With a father from Kenya and a mother from Kansas, President Obama was born in Hawaii on Aug. 4, 1961. He was raised with help from his grandfather . . . ” The second set of search results can include the aforementioned second search result, such as “The nation's 44^{th} president was born on this day in 1961 in Honolulu, two years after the territory was admitted to the union . . . ” The second complex instruction can be, for instance, “use the aforementioned search results to provide your response. If you are unable to use the search results to provide an answer, only then should you use your inherent knowledge to provide an answer”. In this case, the second ground truth response of the second training instance can be, for instance, “Illinois”, an answer that is not found in the first and second search results.

Optionally, the second ground truth response (e.g., “Illinois”) can be generated manually. Optionally, the second ground truth response (e.g., “Illinois”) can be generated, for instance, by processing a prompt formulated based on the second user query of “What state was Obama a senator for?” using a pre-trained LLM. Such a prompt can include, for instance, the second user query of ‘What state was Obama a senator for?” and a simple instruction of, “Provide a response”. In this case, the second ground truth response of “Illinois” can be generated based on a model output of the pre-trained LLM based on processing of the aforementioned prompt, e.g., “What state was Obama a senator for? Provide a response”.

It is noted that, in some implementations, the first (or second) training instance can include a user input in the form of a user command to control one or more external tools (e.g., APIs) instead of question-answering, and include associated side information that provides (or not provides) useful information in generating executable steps to control the one or more external tools. In this case, the instruction to be included in the first (or second) training instance can still be a multi-part instruction including, for instance, a first portion that instructs the pre-trained LLM to use the side information to generate executable steps to perform a task specified in the user command; and a second portion that instructs the pre-trained LLM to use inherent knowledge to generate the executable steps if and only if the side information is not useful.

In some implementations, the first training instance can be utilized to fine tune the pre-trained LLM (e.g., that has been pre-trained based on a large quantity of training datasets to acquire certain inherent knowledge). The first training instance input can be processed as input using the pre-trained LLM, to generate a first model output from which a first response (“first training instance output”) can be generated. The first training instance input can be, for instance, as follows:
“search-result-1: ‘With a father from Kenya and a mother from Kansas, President Obama was born in Hawaii on Aug. 4, 1961. He was raised with help from his grandfather . . . ’
search-result- 2: ‘The nation's 44^{th} president was born on this day in 1961 in Honolulu, two years after the territory was admitted to the union . . . ’
use the aforementioned search results to provide your response. If you are unable to use the search results to provide an answer, only then should you use your inherent knowledge to provide an answer.
Where was President Obama born?”

The first response can be compared to the aforementioned first ground truth response, e.g., “Honolulu, Hawaii”, to determine a first difference, where based on the first difference, parameters of the pre-trained LLM can be fine-tuned.

In some implementations, the second training instance can be utilized to further fine tune the pre-trained LLM. The second training instance input can be processed as input using the pre-trained LLM, to generate a second model output from which a second response (“second training instance output”) can be generated. The second training instance input can be, for instance, as follows:
“search-result-1: ‘With a father from Kenya and a mother from Kansas, President Obama was born in Hawaii on Aug. 4, 1961. He was raised with help from his grandfather . . . ’
search-result-2: ‘The nation's 44^{th} president was born on this day in 1961 in Honolulu, two years after the territory was admitted to the union . . . ’
use the aforementioned search results to provide your response. If you are unable to use the search results to provide an answer, only then should you use your inherent knowledge to provide an answer.
What state was Obama a senator for?”

The second response can be compared to the aforementioned second ground truth response, e.g., “Illinois”, to determine a second difference, where based on the second difference, parameters of the pre-trained LLM can be alternatively or additionally fine-tuned.

It is noted that while the plurality of training instances to fine tune the pre-trained LLM is illustrated to include the first and/or second training instances as described above, the plurality of training instances can alternatively or additionally include a third training instance, a fourth training instance, etc. Put another way, the total number of training instances used to fine tune the pre-trained LLM is not limited to descriptions herein. It is further noted that the specific content of training instance input in each of the plurality of training instances is also not limited to descriptions herein, and can be formulated to include any appropriate user input/query, side information, and/or a corresponding complex instruction.

In various implementations, a method implemented using one or more processors is provided. The method includes: generating a plurality of training instances. In some implementations, the plurality of training instances includes a first training instance formulated to include, as a first training instance input, a first user input, a set of search results, and a multi-part instruction. The multi-part instruction can be a complex instruction to generate a response using the set of search results and only using inherent knowledge to generate the response when the set of search results contain no information for formulating the response. The first training instance can include, as a first ground truth response, a first response to the first user input, where the first response is derived based on the set of search results. In other words, the set of search results in the first training instance are required to provide useful information in generating the first response responsive to the first user input.

Optionally, in some implementations, the set of search results relate to a first entity, and the first user input seeks information (e.g., one or more properties or aspects) relating to the first entity.

In some implementations, the plurality of training instances includes a second training instance that is formulated to include, as a second training instance input, a second user input, the set of search results, and the multi-part instruction. The second user input is different from the first user input. The multi-part instruction is to generate a response using the set of search results and only using inherent knowledge to generate the response when the set of results contain no information for formulating the response. The second training instance can include a second response to the second user input as a second ground truth response, where the set of search results provide no useful information to formulate the second response. The second answer can be generated manually, or be generated based on processing an input prompt (that includes the second user input and a simple instruction to generate a response to the second user input) using a pre-trained LLM.

It is noted that, while the first and second training instances are described above to include the same set of search results, the second training instance can include a different set of search results with respect to the set of search results included in the first training instance. It is further noted that, the first and/or second training instances can each include side information in one or more types other than search result(s), and/or include a complex instruction that may (but does not necessarily need to) vary based on a type of user input (e.g., be it a user query, a user command to interact with an external tool, etc.) that is included in the first (or second) training instance.

In some implementations, optionally, generating the plurality of training instances includes: generating a third training instance. The third training instance includes, as a third training instance input, a third user input, an additional set of search results, and the multi-part instruction. The multi-part instruction is to generate a response using search results and only using inherent knowledge to generate the response when the search results contain no information for formulating the response. The third training instance further includes a third response to the third user input as a third ground truth response. The third response is derived based on the additional set of search results.

In some implementations, alternatively or additionally, generating the plurality of training instances includes: generating a fourth training instance. The fourth training instance includes, as a fourth training instance input, a fourth user input different from the third user input, the additional set of search results, and the multi-part instruction. The multi-part instruction is to generate a response using search results and only using inherent knowledge to generate the response when the search results contain no information for formulating the response. The fourth training instance further includes a fourth response to the fourth user input as a fourth ground truth response. The fourth response can be derived based on the fourth user input and using the pre-trained LLM (or a different LLM).

In various implementations, the method further includes: fine tuning a generative model (e.g., the above pre-trained LLM used to formulate the second answer, or a different LLM) using the plurality of generated training instances. In some implementations, fine tuning the generative model using the generated plurality of training instances includes: fine tuning the generative model using the first training instance (as described above), and/or fine tuning the generative model using the second training instance (as described above). In some implementations, fine tuning the generative model using the first training instance includes: processing the first training instance input as input, using the generative model, to generate first model output from which a first response is determined; comparing the first response with the first ground truth response; and fine tuning the generative model based on comparing the first response with the first ground truth response.

In some implementations, fine tuning the generative model using the second training instance includes: processing the second training instance input as input, using the generative model, to generate second model output from which a second response is determined; comparing the second response with the second ground truth response; and fine tuning the generative model based on comparing the second response with the second ground truth response.

In various implementations, an additional method implemented using one or more processors is provided. The additional method is about utilizing a fine-tuned LLM to generate a response, and the additional method includes: receiving a user input (e.g., a user query or request seeking information of an entity); and in response to receiving the user input, generating a textual prompt that includes the user input, one or more search results responsive to the user input, as well as a multi-part instruction. The multi-part instruction in the textual prompt can include a first description/portion to generate a response using search results and a second description to only use inherent knowledge to generate the response when the search results contain no information for formulating the response. The additional method further includes: processing the textual prompt using the fine-tuned LLM, to generate a model output from which the response (to the user input) is derived; and causing the response to be rendered.

In some implementations, the fine-tuned LLM is acquired based on tune fining a pre-trained LLM using a plurality of training instances. The plurality of training instances include, for instance, the first and/or second training instances as described above. In some implementations, the pre-trained LLM, for instance, can include at least hundreds of millions of parameters. The pre-trained LLM can alternatively include at least billions of parameters, such as one hundred billion or more parameters. In some implementations, the pre-trained LLM is a sequence-to-sequence model, is Transformer-based, and/or can include an encoder and/or a decoder. One non-limiting example of the pre-trained LLM is GOOGLE'S Pathways Language Model (PaLM). Another non-limiting example of an LLM is GOOGLE'S Language Model for Dialogue Applications (LaMDA).

The preceding is presented as an overview of only some implementations disclosed herein. These and other implementations are disclosed in additional detail herein. For example, additional and/or alternative implementations are disclosed herein such as those fine-tuning the pre-trained LLM to perform different tasks using different training instances that each utilize a complex instruction phrasing a corresponding task.

Various implementations can include a non-transitory computer readable storage medium storing instructions executable by a processor to perform a method such as one or more of the methods described herein. Yet other various implementations can include a system including memory and one or more hardware processors operable to execute instructions, stored in the memory, to perform a method such as one or more of the methods described herein.

### BRIEF DESCRIPTION OF THE DRAWINGS

FIG. 1A depicts a block diagram of an example environment that demonstrates various aspects of the present disclosure, and in which some implementations disclosed herein can be implemented.

FIG. 1B illustrates an example scenario where a fine-tuned LLM is utilized in responding to user input, in accordance with various implementations disclosed herein.

FIG. 1C illustrates an example flowchart showing generation of a first training instance to fine tune a pre-trained LLM, in accordance with various implementations disclosed herein.

FIG. 1D illustrates an example flowchart showing generation of a second training instance to fine tune a pre-trained LLM, in accordance with various implementations disclosed herein.

FIG. 1E illustrates an example flowchart showing generation of a third training instance to fine tune a pre-trained LLM, in accordance with various implementations disclosed herein.

FIG. 1F illustrates an example flowchart showing generation of a fourth training instance to fine tune a pre-trained LLM, in accordance with various implementations disclosed herein.

FIG. 2A depicts an example of first training instance input, in accordance with various implementations disclosed herein.

FIG. 2B depicts an example of second training instance input, in accordance with various implementations disclosed herein.

FIG. 3 depicts a flowchart illustrating an example method of generating training instance(s) for fine-tuning a pre-trained LLM into a fine-tuned LLM, in accordance with various aspects of the present disclosure.

FIG. 4 depicts a flowchart illustrating an example method of utilizing a fine-tuned LLM in responding to user input, in accordance with various aspects of the present disclosure.

FIG. 5 depicts an example architecture of a computing device, in accordance with various implementations.

### DETAILED DESCRIPTION

The following description with reference to the accompanying drawings is provided for understanding of various implementations of the present disclosure. It's appreciated that different features from different embodiments may be combined with and/or exchanged for one another. In addition, those of ordinary skill in the art will recognize that various changes and modifications of the various embodiments described herein can be made without departing from the scope and spirit of the present disclosure. Descriptions of well-known or repeated functions and constructions may be omitted for clarity and conciseness.

The terms and words used in the following description and claims are not limited to the bibliographical meanings, and are merely used by the inventor to enable a clear and consistent understanding of the present disclosure. Accordingly, it should be apparent to those skilled in the art that the following description of various embodiments of the present disclosure is provided for the purpose of illustration only and not for the purpose of limiting the present disclosure as defined by the appended claims and their equivalents.

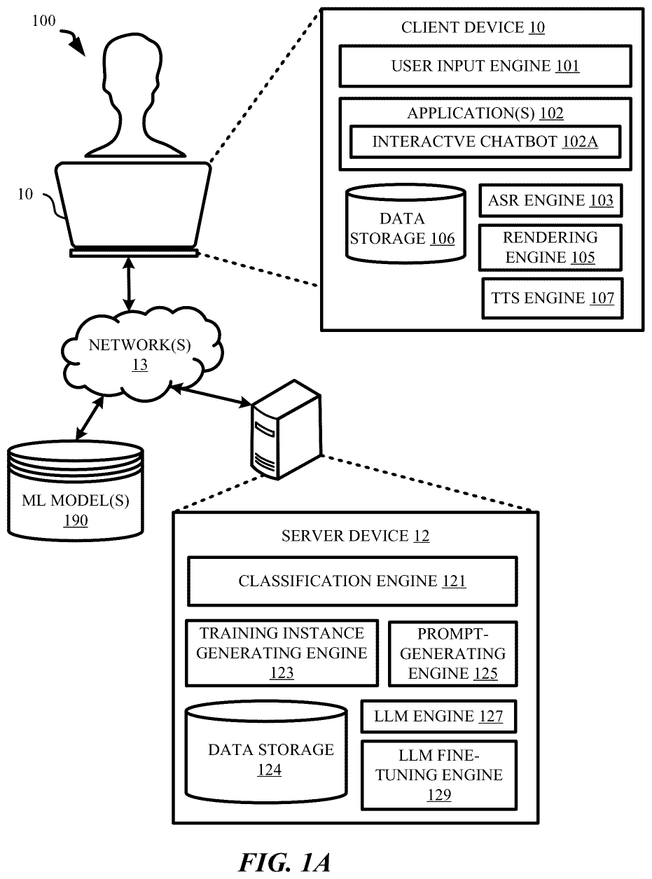

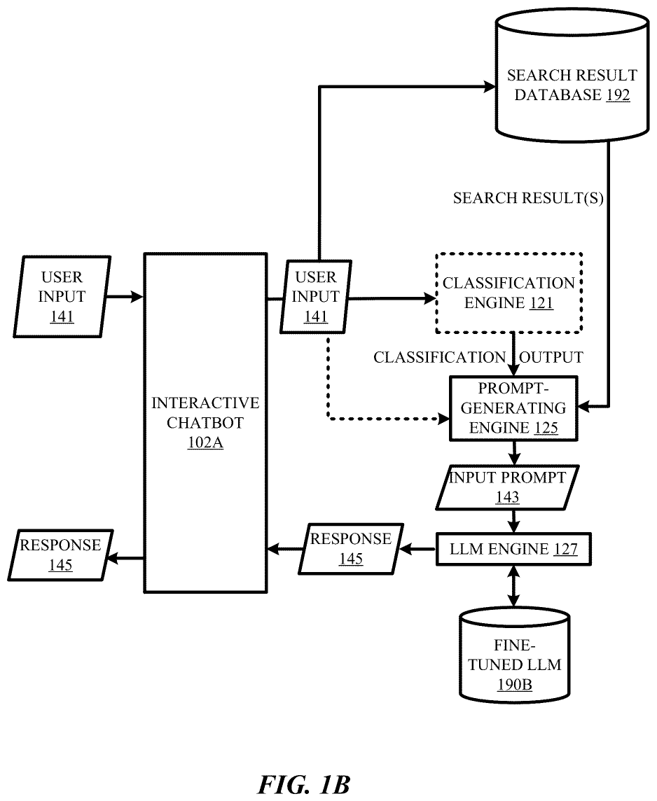

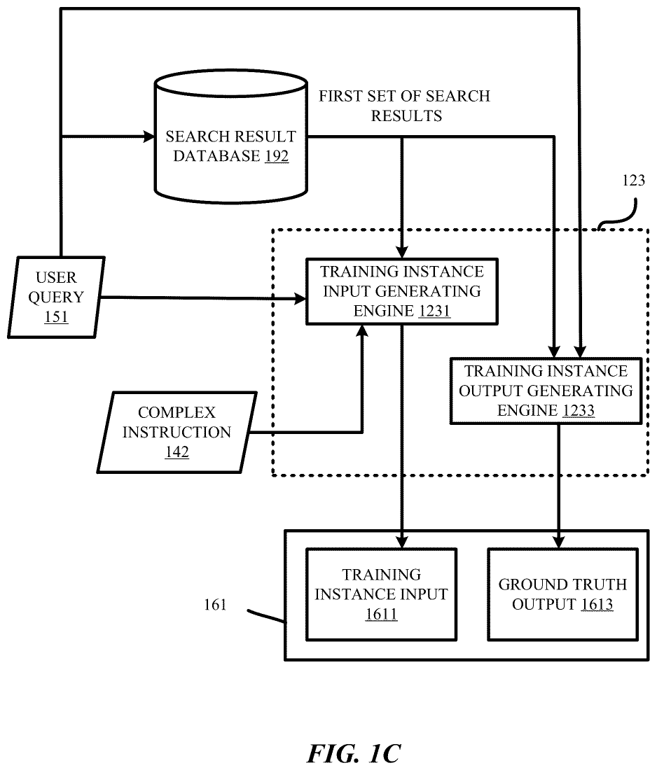

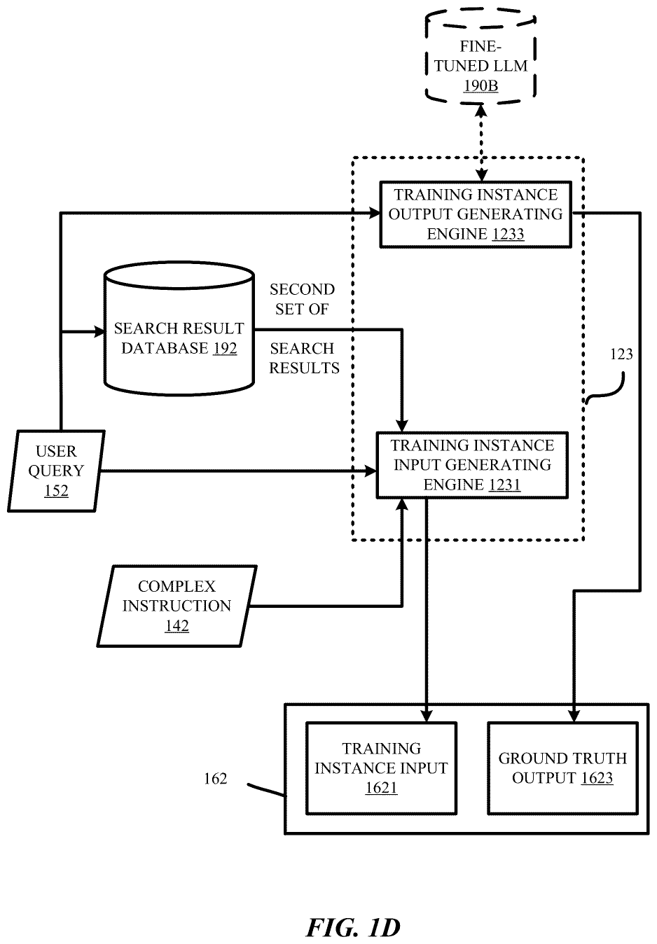

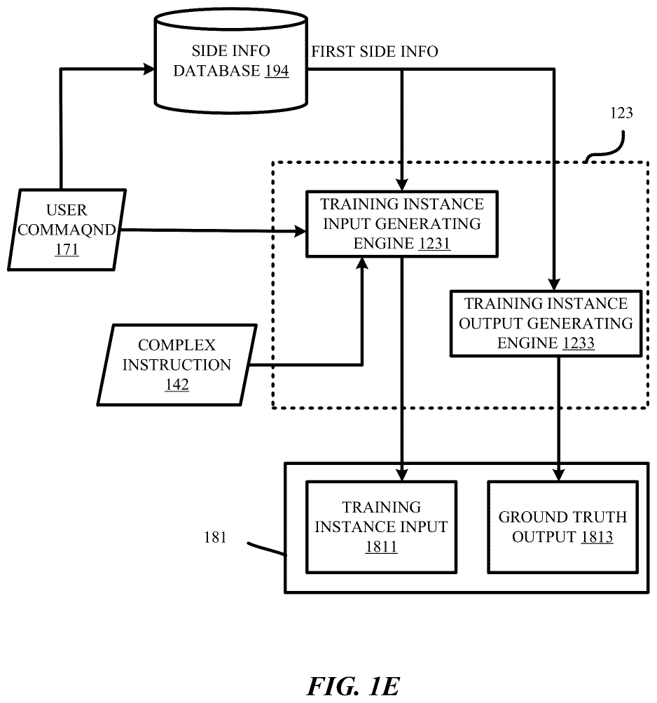

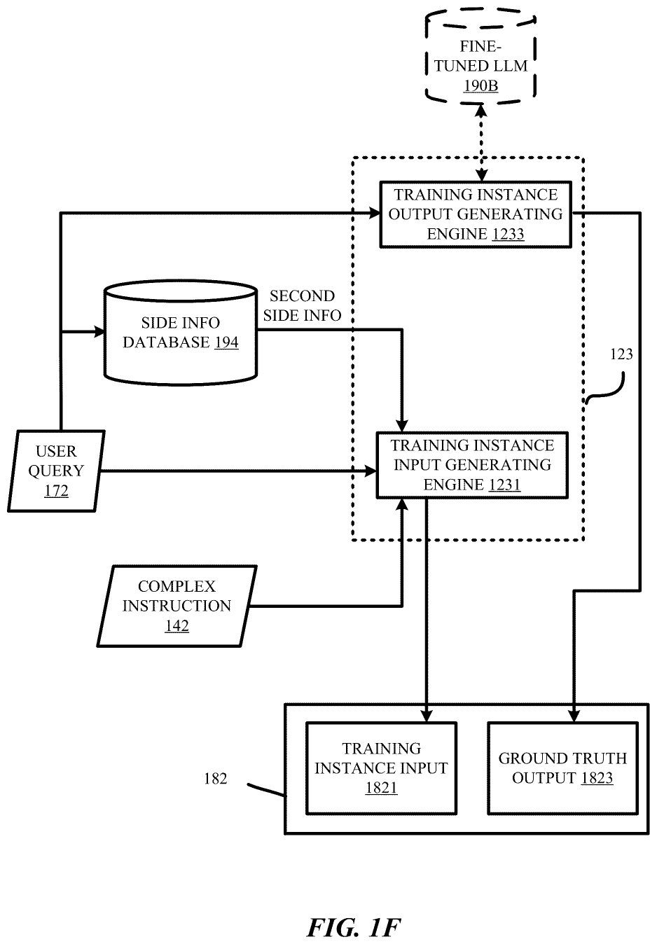

FIG. 1A is a block diagram of an example environment 100 that demonstrates various aspects of the present disclosure, and in which implementations disclosed herein may be implemented. As shown in FIG. 1A, the environment 100 can include a client computing device 10 (“client device”), and a server computing device 12 (“server device”) in communication with the client computing device 10. The server computing device 12 can communicate with the client computing device 10 via one or more networks 13.

The one or more networks 13 can include, for example, a local area network (LAN), a wide area network (WAN) such as the Internet, and/or any other appropriate network. In some implementations, the client computing device 10 can include, or other access one or more machine learning (ML) models 190 via the one or more networks 13. Additionally or alternatively, the server computing device 12 in communication can include, or other access the one or more machine learning (ML) models 190 via the one or more networks 13. The one or more ML models 190 can include, for instance, one or more pre-trained LLMs and/or one or more fine-tuned LLMs.

The client computing device 10 can be, for example, a desktop computing device, a laptop computing device, a tablet computing device, a mobile phone computing device, a computing device of a vehicle (e.g., an in-vehicle entertainment or navigation system), an interactive speaker, a smart appliance such as a smart television, and/or a wearable apparatus that includes a computing device (e.g., glasses having a computing device, a smart watch, a virtual or augmented reality computing device), and the present disclosure is not limited thereto.

In various implementations, the client computing device 10 can include software component(s) such as a user input engine 101 and/or hardware component(s) such as input and output (I/O) device(s). The I/O device(s) can include, for instance, one or more speakers and one or more microphones. In some implementations, the I/O device(s) can include other hardware component(s) such as a display to visually render natural language content and/or visual content, and/or a keyboard (not depicted) to receive typed input, touch input, or other types of input.

The user input engine 101 can be configured to detect user input provided by a user of the client computing device 10 using one or more of the input devices. For example, the aforementioned keyboard can receive typed input. As another example, the client computing device 10 can be equipped with a mouse (or one or more hardware buttons) to receive a user click that selects one or more graphical user interface (GUI) elements that is rendered visually at a user interface of the client computing device 10. Additionally, or alternatively, the one or more microphones can capture audio data, such as audio data corresponding to spoken utterances of the user or other sounds in an environment of the client computing device 10. Additionally, or alternatively, the client computing device 10 can be equipped with one or more vision components (e.g., a camera) that are configured to capture vision data corresponding to images and/or movements (e.g., gestures, etc.) detected in a field of view of one or more of the vision components. Additionally, or alternatively, the client computing device 10 can be equipped with one or more touch sensitive components (e.g., a stylus, a touch screen, a touch panel, etc.) that are configured to capture signal(s) corresponding to touch input directed to the client computing device 10.

In various implementations, the client computing device 10 can further include one or more applications 102. The one or more applications 102 can include, for instance, an interactive chatbot 102A. In some implementations, the interactive chatbot 102A can include or otherwise access, for instance, an automatic speech recognition (ASR) engine 103. The ASR engine 103 can process audio data that captures a spoken utterance to generate a speech recognition of the spoken utterance. In some implementations, the audio data that captures the spoken utterance can be determined as being directed to the interactive chatbot 102A. For instance, the audio data that captures the spoken utterance can be determined as being directed to the interactive chatbot 102A based on the audio data that captures the spoken utterance being received while the interactive chatbot 102A is running at the client computing device 10. In this case, the speech recognition of the spoken utterance can be rendered visually (e.g., using a rendering engine 105) via a chat interface of the interactive chatbot 102A.

In some implementations, optionally, the interactive chatbot 102A can include, or otherwise access, a prompt-generating engine 125 and/or an LLM engine 127. In some implementations, optionally, the interactive chatbot 102A can include, or otherwise access, a classification engine 121. The classification engine 121 can classify, for instance, the aforementioned speech recognition of the spoken utterance (or a typed user input received via the interactive chatbot 102A) into a user input that seeks a response, a user command to perform a task utilizing an external tool (e.g., API), etc.

In some implementations, an input prompt can be generated (e.g., using the prompt-generating engine 125) to include the user query (which can be received via the interactive chatbot 102A) and/or a complex instruction. The complex instruction can be a multi-part instruction that guides a fine-tuned LLM to decide whether to utilize side information such as search result(s) in generating a response to the user query. For instance, the complex instruction can be, e.g., “use the aforementioned search results to provide your response. If you are unable to use the search results to provide an answer, only then should you use your inherent knowledge to provide an answer”. The input prompt can be processed by the LLM engine 127 using the fine-tuned LLM, to generate a model output from which a response (responsive to the user query) is derived.

In some implementations, the rendering engine 105 can cause the generated response to be rendered (for instance, at the chat interface of the interactive chatbot 102A) in response to the speech recognition of the user utterance (or the typed input) as described above.

In some implementations, the fine-tuned LLM can be acquired by fine-tuning a pre-trained LLM. The pre-trained LLM, for instance, can include at least hundreds of millions of parameters. The pre-trained LLM can alternatively include at least billions of parameters, such as one hundred billion or more parameters. In some implementations, the pre-trained LLM is a sequence-to-sequence model, is Transformer-based, and/or can include an encoder and/or a decoder. One non-limiting example of the pre-trained LLM is GOOGLE'S Pathways Language Model (PaLM). Another non-limiting example of the pre-trained LLM is GOOGLE'S Language Model for Dialogue Applications (LaMDA). The pre-trained LLM can be pre-trained using a large quantity of training datasets to acquire certain inherent knowledge.

In some implementations, a training instance generating engine 123 (e.g., at the service device 12 or at the client computing device 10, or shared therebetween) can be utilized to generate a plurality of training instances to fine-tune the pre-trained LLM. In some implementations, the plurality of the training instances used to fine-tune the pre-trained LLM can be a relatively small set of training instances compared to the

By using the plurality of training instances to fine tune the pre-trained LLM into the fine tuned LLM, the fine tuned LLM can determine whether to utilize side information (e.g., search results) in formulating a response responsive to a user input. Utilization of side information that includes information to formulate the response can reduce the chance that an inaccurate or hallucinated response is generated. Utilization of the inherent knowledge of the LLM when the side information does not include useful information to formulate the response can ensure that a response responsive to the user input is generated. Optionally, the plurality of training instances to fine tune the pre-trained LLM can each include the same complex instruction. This can reduce the computational resources consumed, e.g., when using the training instance generating engine 123 to generate the plurality of training instances. Optionally, the plurality of training instances to fine tune the pre-trained LLM can each include the same complex instruction can include one or more complex instructions. This may accommodate the needs to guide the LLM in generating responses to different types of user input.

In some implementations, the interactive chatbot 102A can include, but does not necessarily need to include, a NLU engine (not depicted) to determine semantic meaning(s) of a text (e.g., the aforementioned typed input or speech recognition of the user utterance) and/or the audio (e.g., the aforementioned audio data capturing the spoken utterance). The NLU engine can decompose the determined semantic meaning(s) to determine intent(s) and/or parameter(s) for an action (e.g., generating a response) performable via the interactive chatbot 102A. For instance, the NLU engine can process natural language content of “weather today?”, to determine a natural language understanding (NLU) intent of “search” and/or parameters (e.g., “weather” and “today”) for an action of searching the Internet for weather today.

In some implementations, the NLU engine can resolve the intent(s) and/or parameter(s) based on a single utterance of a user and, in other situations, prompts can be generated based on unresolved intent(s) and/or parameter(s). In this latter situation, the generated prompts can be rendered (e.g., visually and/or audibly) to the user to receive user response(s), where the user response(s) to the rendered prompt(s) can be utilized by the NLU engine in resolving intent(s) and/or parameter(s). Optionally, the NLU engine can work in concert with a dialog manager engine (not illustrated) that determines unresolved intent(s) and/or parameter(s). For instance, the dialog manager engine can be alternatively or additionally utilized to generate the aforementioned prompt(s). In some implementations, the NLU engine can utilize one or more NLU machine learning models in determining intent(s) and/or parameter(s).

In some implementations, the interactive chatbot 102A can, but does not necessarily need to, include a fulfillment engine (not depicted). In some implementations, the fulfillment engine can receive an intent and/or parameter(s) of the intent, to fulfill the intent by performing a corresponding action.

In some implementations, the interactive chatbot 102A can, but does not necessarily need to, a text-to-speech (TTS) engine 107. The TTS engine 107 can convert a text to a synthesized speech (e.g., using a particular voice), for instance, when the text includes responsive content generated in response to a spoken utterance from a user. The synthesized speech, for instance, can be generated by using one or more trained speech synthesis neural network models to process the text. The synthesized speech can be audibly rendered via hardware speaker(s) of the client computing device 10 (e.g., a stand-alone speaker) or via another device (e.g., a cell phone).

In some implementations, the client computing device 10 can include a data storage 106. The data storage 106 can store various types of files and/or data. For instance, the data storage 106 can store application data of the interactive chatbot 102A (and/or one or more additional applications), user data (e.g., one or more user profiles) of a user of the client computing device 10, and/or other metadata. The one or more additional applications can include, for example, a social media application, a video player, a note-taking application, a shopping application, a messaging application, and/or any other appropriate applications (or services), installed at (or accessible via) the client computing device 10.

The server computing device 12 can be, for example, a web server, one or more blade servers acting together to provide “cloud” infrastructure, or any other type of server as needed. In various implementations, the server computing device 12 can include cloud-based components the same as or similar to hardware and/or software components of the client computing device 1. The same or similar descriptions are omitted herein for the sake of brevity. In some implementations, the server computing device 12 (and/or the client computing device 10) can include a data storage 124 that stores training instance(s) to fine tune the pre-trained LLM, and/or side information such as search result(s) or search result document(s), etc.

FIG. 1B illustrates an example scenario where a fine-tuned LLM is utilized in responding to user input, in accordance with various implementations disclosed herein. As shown in FIG. 1B, a user input 141 can be received (e.g., via an interactive chatbot 102A or another app) at a client device. The user input 141 can be, for instance, a typed input received via an input field of the interactive chatbot. Alternatively, the user input 141 can be a transcript of audible input received at one or more microphones of the client device. The transcript of audible input can be determined based on processing the audible input using the aforementioned ASR engine 103, where the ASR engine 103 can be included in, or otherwise be coupled to, the interactive chatbot 102A. In some implementations, the user input 141 (e.g., typed input or transcript of audible input) can be forward to the prompt-generating engine 125.

The prompt-generating engine 125 can formulate an input prompt 143 (may also referred to as “prompt” or sometimes “textual prompt”, etc.) that includes the user input 141, side information (e.g., search result(s) responsive to the user input 141, as shown in FIG. 1B), and a complex instruction that guides a fine-tuned LLM (e.g., 190B) in deciding whether or not to utilize side information such as search results to formulate a response for the user input 141. The search result(s) can be acquired, for instance, from a search result database 192, based on determining that the search result(s) are responsive to the user input 141. The complex instruction can be a multi-part instruction that includes a first portion that instructs the pre-trained LLM to use search results to generate a response responsive to the user query; and a second portion that instructs the pre-trained LLM to use inherent knowledge to generate the response if and only if the search results are not useful in generating the response.

As a non-limiting example, the complex instruction can be: “use the aforementioned side information to respond to user input. If you are unable to use the side information, only then should you use your inherent knowledge to respond to the user input”. Such complex instruction can be included in all of the training instances used to fine tune a pre-trained LLM. Such complex instruction can be included in the input prompt 143 and remain unchanged for different user input.

Optionally, the search result database 192 can include a plurality of search results collected from previous user queries, where the previous user queries can be from different users. Optionally, the plurality of search results can be grouped based on entities identified in each of the plurality of search results. For instance, the plurality of search results can be divided into a first group of search results each associated with a first entity, a second group of search results each associated with a second entity, . . . , and an N^{th} group of search results each associated with an N^{th} entity, where N is a positive integer greater than or equal to 1. The first, second, . . . , and N^{th} entities can be distinct from each other. Put another way, in some implementations, optionally, each group of search results can be associated with a distinct entity and be stored in a distinct search result document for the distinct entity.

Optionally, in some implementations, the user input 141 can be additionally classified using the classification engine 121, where the classification engine 121 can output a classification output (e.g., classification label) indicating a classification or category of the user input 141. In this case, content of the complex instruction that the prompt-generating engine 125 used to formulate the input prompt can depend on the classification output. In other words, different complex instructions can be retrieved by the prompt-generating engine 125 for different categories of user input. For instance, a complex instruction of “use the aforementioned search results to provide your response. If you are unable to use the search results to provide an answer, only then should you use your inherent knowledge to provide an answer” can be retrieved for the user input 141 if the user input 141 is classified as a “user query”. A different complex instruction of “use the aforementioned documents to provide executable steps. If you are unable to use the documents, only then should you use your inherent knowledge to provide the executable steps” can be retrieved for the user input 141 if the user input 141 is classified as a “user query”.

In some implementations, the input prompt 143 generated by the prompt-generating engine 125 based on the user input 141 can be processed using the LLM engine 127, to generate a model output from which a response 145 responsive to the user input 141 can be generated. The response 145 can be rendered to a user, for instance, via a user interface (audible or graphical) of the interactive chatbot 102A.

FIG. 1C illustrates an example flowchart showing generation of a first training instance to fine tune a pre-trained LLM, in accordance with various implementations disclosed herein. FIG. 1D illustrates an example flowchart showing generation of a second training instance to fine tune a pre-trained LLM, in accordance with various implementations disclosed herein.

As shown in FIG. 1C, a user query 151 can be formulated. For instance, the user query 151 can be, “Where was President Obama born?” A first set of search results having information to formulate an answer to the user query 151 can be selected (e.g., from a search result database 192). Additionally, a complex instruction 142 can be formulated. The user query 151, the first set of search results, and the complex instruction 142 can be provided to a training instance input generating engine 1231 of the training instance generating engine 123. The training instance input generating engine 1231 can generate a training instance input 1611 that includes the user query 151, the first set of search results, and the complex instruction 142.

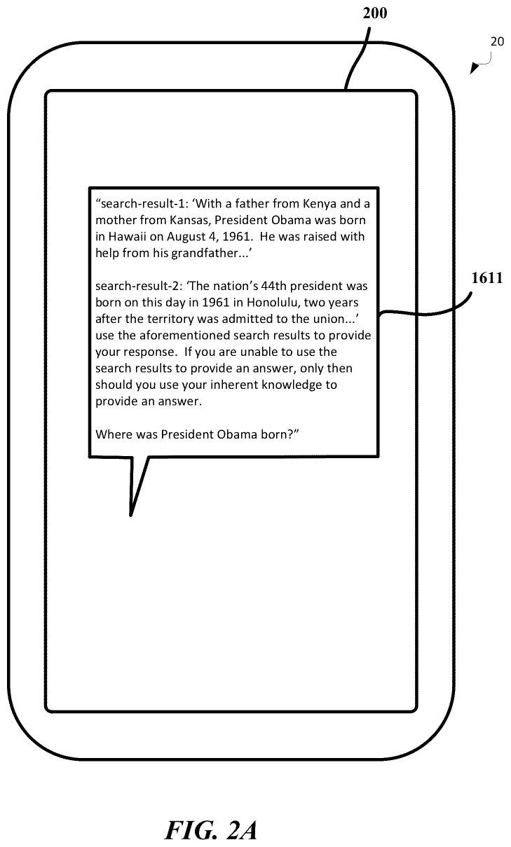

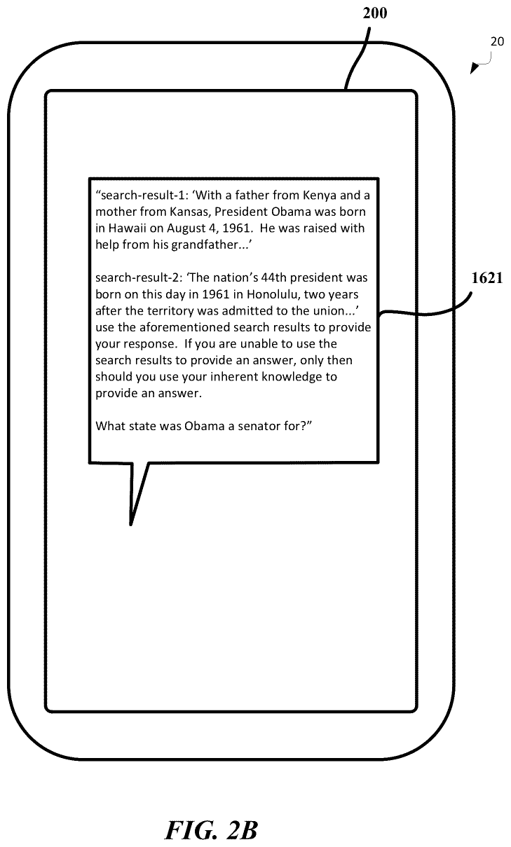

Referring to FIG. 2A, during fine-training of the pre-trained LLM, the training instance input 1611 that includes the user query 151, the first set of search results, and the complex instruction 142 can be received via a user interface 200 of a computing device 20. The training instance input 1611 can be as follows:
“search-result-1: ‘With a father from Kenya and a mother from Kansas, President Obama was born in Hawaii on Aug. 4, 1961. He was raised with help from his grandfather . . . ’
search-result-2: ‘The nation's 44^{th} president was born on this day in 1961 in Honolulu, two years after the territory was admitted to the union . . . ’
use the aforementioned search results to provide your response. If you are unable to use the search results to provide an answer, only then should you use your inherent knowledge to provide an answer.
Where was President Obama born?”

Optionally, the first set of search results and/or the user input 141 can be provided to a training instance output generating engine 1233 of the training instance generating engine 123, to generate a ground truth response/output 1613. The training instance output generating engine 1233 can, for instance, forward the first set of search results to a prompt-generating engine (e.g., 125), to generate a prompt (not illustrated) that includes the user query 151, the first set of search results, and a simple instruction to formulate an answer to the user query 151 using the first set of search results. Such prompt can be processed using a generative model (a pre-trained LLM to be fine-tuned or another LLM), to generate a model output from which the ground truth response/output 1613 can be derived. The ground truth response/output 1613 responsive to the user query 151 of “Where was President Obama born?” can be, e.g., “Honolulu, Hawaii”.

The training instance input 1611 and the ground truth output 1613 can be included in a first training instance 161 for fine tuning the pre-trained LLM. To fine tune the pre-trained LLM, the training instance input 1611 can be processed as input using the pre-trained LLM to generate a model output from which a first training instance output is derived. The first training instance output can be compared to the ground truth output 1613, and parameters of the pre-trained LLM can be fine tuned based on comparing the first training instance output with the ground truth output 1613.

Now turning to FIG. 1D, a user query 152 can be formulated. For instance, the user query 152 can be, “What state was Obama a senator for?” A second set of search results not including information to formulate a response to the user query 152 can be identified or selected (e.g., from the search result database 192). The second set of search results can be, but do not necessarily need to be, the same as the first set of search results. The user query 152, the second set of search results, and the complex instruction 142 can be provided to the training instance input generating engine 1231. The training instance input generating engine 1231 can generate a training instance input 1621 that includes the user query 152, the second set of search results, and the complex instruction 142.

Referring to FIG. 2B, during fine-training of the pre-trained LLM, the training instance input 1621 that includes the user query 152, the second set of search results, and the complex instruction 142 can be received via the user interface 200 of a computing device 20. The training instance input 1621 can be as follows:
“search-result-1: ‘With a father from Kenya and a mother from Kansas, President Obama was born in Hawaii on Aug. 4, 1961. He was raised with help from his grandfather . . . ’
search-result- 2: ‘The nation's 44^{th} president was born on this day in 1961 in Honolulu, two years after the territory was admitted to the union . . . ’
use the aforementioned search results to provide your response. If you are unable to use the search results to provide an answer, only then should you use your inherent knowledge to provide an answer.
What state was Obama a senator for?”

The user query 152 can be provided to the training instance output generating engine 1233, to generate a ground truth response/output 1623. The ground truth response/output 1623 can be, e.g., “Illinois”. The ground truth output 1623, for instance, can be generated based on processing a prompt that includes the user query 152 as input using a trained LLM. Such prompt herein can be, for instance, “What state was Obama a senator for? provide a response”. The training instance input 1621 and the ground truth output 1623 can be included in a second training instance 162 for fine tuning a pre-trained LLM. To fine tune the pre-trained LLM, the training instance input 1621 can be processed using the pre-trained LLM to generate a model output from which a second training instance output is derived. The second training instance output can be compared to the ground truth output 1623, and parameters of the pre-trained LLM can be fine tuned based on comparing the second training instance output with the ground truth output 1623.

FIG. 1E illustrates an example flowchart showing generation of a third training instance to fine tune a pre-trained LLM, in accordance with various implementations disclosed herein. FIG. 1F illustrates an example flowchart showing generation of a fourth training instance to fine tune a pre-trained LLM, in accordance with various implementations disclosed herein. As shown in FIG. 1E, a user command 171 to perform a task (e.g., using external tools) can be formulated. Side information having information to formulate executable steps for performing the task can be identified or selected (e.g., from a side information database 194). Additionally, a complex instruction 144 can be formulated to phrase the task. The user command 171, the side information, and the complex instruction 144 can be provided to the training instance input generating engine 1231. The training instance input generating engine 1231 can generate a training instance input 1811 that includes the user command 171, the side information, and the complex instruction 144.

The side information and/or the user command 171 can be provided to the training instance output generating engine 1233, to generate a ground truth output 1813. The training instance output generating engine 1233 can, for instance, forward the received side information to a prompt-generating engine (e.g., 125 in FIG. 1A) to generate a prompt that includes the user command 171, the side information, and a simple instruction to formulate a response to the user command 171 using the side information. Such prompt can be processed using the pre-trained LLM or another LLM, to generate a model output from which the ground truth output 1813 can be derived.

The training instance input 1811 and the ground truth output 1813 can be included in a third training instance 181 for fine tuning a pre-trained LLM. To fine tune the pre-trained LLM, the third training instance input 1811 can be processed using the pre-trained LLM to generate a model output from which a third training instance output is derived. The third training instance output can be compared to the ground truth output 1813, and parameters of the pre-trained LLM can be fine tuned based on comparing the third training instance output with the ground truth output 1813.

Now turning to FIG. 1F, a user command 172 to perform an additional task using external tools can be formulated. Side information not including information to formulate executable steps for the additional task can be selected (e.g., from the side information database 194). The user command 172, the additional side information, and the complex instruction 144 can be provided to the training instance input generating engine 1231. The training instance input generating engine 1231 can generate a training instance input 1821 that includes the user command 172, the additional side information, and the complex instruction 144.

The user command 172 can be provided to the training instance output generating engine 1233, to generate a ground truth output 1823. The ground truth output 1823, for instance, can be generated based on processing a prompt that includes the user command 172 as input using a trained LLM. The training instance input 1821 and the ground truth output 1823 can be included in a fourth training instance 182 for fine tuning a pre-trained LLM. To fine tune the pre-trained LLM, the training instance input 1821 can be processed using the pre-trained LLM to generate a model output from which a fourth training instance output is derived. The fourth training instance output can be compared to the ground truth output 1823, and parameters of the pre-trained LLM can be fine tuned based on comparing the fourth training instance output with the ground truth output 1823.

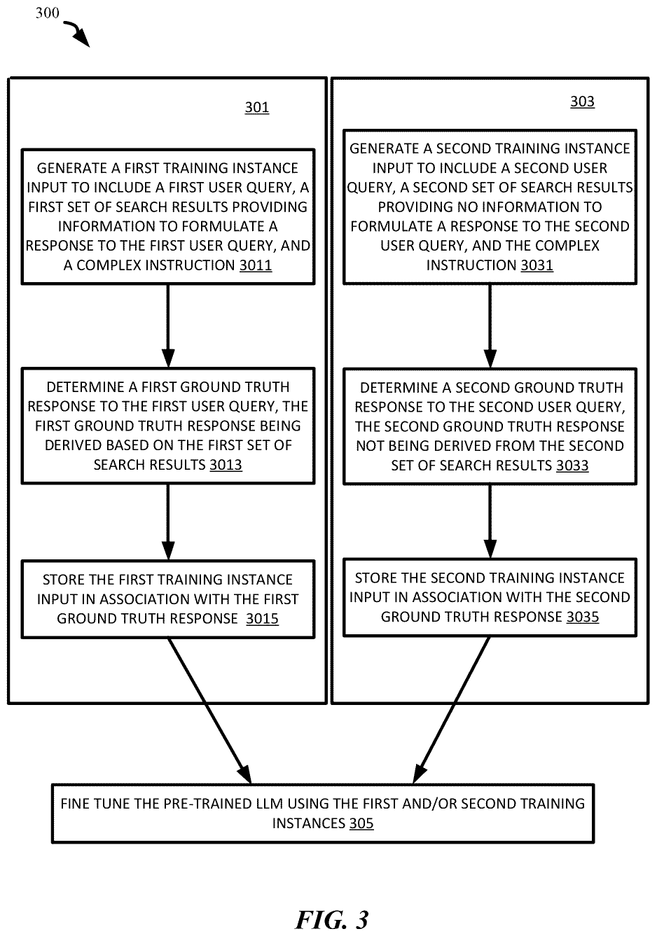

Turning now to FIG. 3, a flowchart illustrating an example method of generating training instance(s) for fine-tuning a pre-trained LLM into a fine-tuned LLM is provided, in accordance with various aspects of the present disclosure. For convenience, the operations of the method 300 are described with reference to a system that performs the operations. This system of the method 300 includes one or more processors, memory, and/or other component(s) of computing device(s) (e.g., client computing device 10 of FIG. 1, one or more servers, and/or other computing devices). Moreover, while operations of the method 300 are shown in a particular order, this is not meant to be limiting. One or more operations may be reordered, omitted, and/or added.

In various implementations, the system can generate a plurality of training instances to fine tune a pre-trained LLM (block 300). The system can generate the plurality of training instances by: generating a first training instance (block 301) and/or a second training instance (block 303).

In some implementations, generating the first training instance (block 301) includes: generating a first training instance input (block 3011) to include a first user query, a first set of search results providing information to formulate a response to the first user query, and a complex instruction. The complex instruction can be a multi-part instruction that instructs to generate a response using search results and only using inherent knowledge to generate the response when the search results contain no information for formulating the response. In some implementations, generating the first training instance (block 301) further includes: at block 3013, determining a first ground truth response to the first user query, the first ground truth response being derived based on the first set of search results. In some implementations, generating the first training instance (block 301) further includes: at block 3015, storing the first training instance input in association with the first ground truth response, in the first training instance.

In some implementations, generating the second training instance (block 303) includes: at block 3031, generating a second training instance input to include a second user query, a second set of search results, and the complex instruction. Optionally, the second set of search results can be the same as (or different from) the first set of search results. Regardless of the second set of search results being the same as or different from the first set of search results, the second set of search results provide no information to formulate a response to the second user query. The complex instruction can be the multi-part instruction as described above, which instructs to generate a response using search results and only using inherent knowledge to generate the response when the search results contain no information for formulating the response.

In some implementations, generating the second training instance (block 303) further includes: at block 3033, determining a second ground truth response to the second user query, the second ground truth response not being derived from the second set of search results. In some implementations, generating the second training instance (block 303) further includes: at block 3035, storing the second training instance input in association with the second ground truth response, in the second training instance.

In some implementations, the method can further include, at block 305, fine tuning the pre-trained LLM using the first and/or second training instances. In some implementations, fine tuning the pre-trained LLM using the first training instance includes: processing the first training instance input using the pre-trained LLM to generate a first training instance output; comparing the first training instance output with the first ground truth response; and fine tuning the pre-trained LLM based on the comparing of the first training instance output with the first ground truth response. In some implementations, additionally or alternatively, fine tuning the pre-trained LLM using the second training instance includes: processing the second training instance input using the pre-trained LLM to generate a second training instance output; comparing the second training instance output with the second ground truth response; and fine tuning the pre-trained LLM based on the comparing of the second training instance output with the second ground truth response.

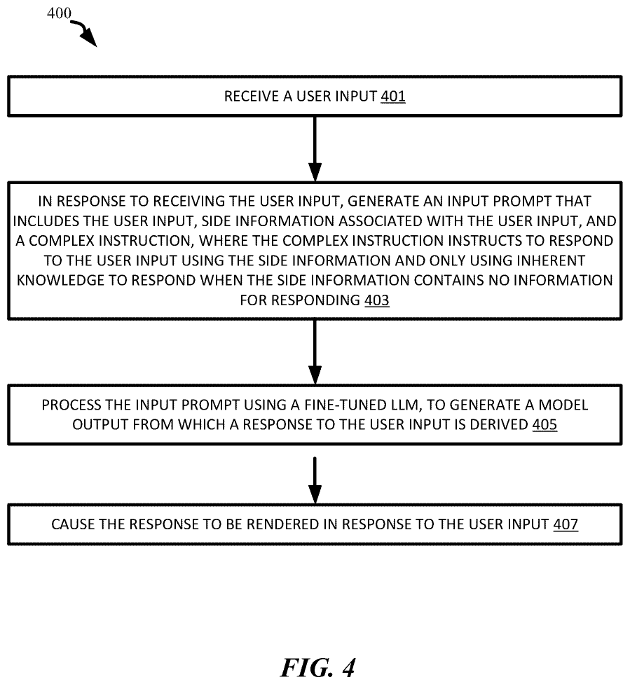

Turning now to FIG. 4, a flowchart illustrating an example method of utilizing a fine-tuned LLM in responding to user input is provided, in accordance with various aspects of the present disclosure. This system of the method 400 includes one or more processors, memory, and/or other component(s) of computing device(s) (e.g., client computing device 10 of FIG. 1, one or more servers, and/or other computing devices). Moreover, while operations of the method 400 are shown in a particular order, this is not meant to be limiting. One or more operations may be reordered, omitted, and/or added.

At block 401, the system receives a user input. Optionally, the user input can be received via a user interface of an application installed at, or accessible, via a client device. The user input can be a typed input, a transcript of audible input, or any other applicable type of input. The application can be, for instance, an interactive chatbot or any other applicable application. The user input can be a user query seeking information (e.g., a property or other perspective) of an entity, or a user command to control an external device or tool, or any other applicable input.

At block 403, the system, in response to receiving the user input, generates an input prompt that includes the user input, side information associated with the user input, and a complex instruction to respond to the user input using the side information and only using inherent knowledge to respond when the side information contains no information for responding. In some implementations, the user input is a user query, and the side information includes one or more search results responsive to the user query. The one or more search results, for instance, can be identified from a search result database based on the one or more search results being responsive to an entity of the user query.

In some implementations, optionally, the complex instruction can remain the same for different user inputs that belong to the same category or that belong to different categories. In some other implementations, optionally, content of the complex instruction can depend on a category or classification of the user input. Put another way, different complex instructions can be used for user inputs belonging to different categories. For instance, a first complex instruction can be used for the user input if the user input includes a user query, and a second complex instruction (different from the first complex instruction) can be used for the user input if the user input includes a user command.

At block 405, the system processes the input prompt using a fine-tuned LLM, to generate a model output from which a response to the user input is derived.

In some implementations, the fine-tuned LLM can be acquired by fine-tuning a pre-trained LLM using a plurality of training instances. The plurality of training instances can include a first training instance and/or a second training instance.

The first training instance can be generated to include a first training instance input and a first ground truth response. The first training instance input can be formulated to include a first user query, a first set of search results providing information to formulate a response to the first user query, and a complex instruction that instructs to generate a response using search results and only using inherent knowledge to generate the response when the search results contain no information for formulating the response. The first ground truth response is derived based on the first set of search results.

The second training instance can be generated to include a second training instance input and a second ground truth response. The second training instance input can include a second set of search results (the same as or different from the first set of search results), a second user query that is so formulated that the second set of search results provide no information to formulate a response to the second user query, and the complex instruction. The second ground truth response is not derived based on the one or more search results.

At block 407, the system causes the response to be rendered in response to the user input. The response to the user input can be rendered visually and/or audibly, based on a format of the user input.

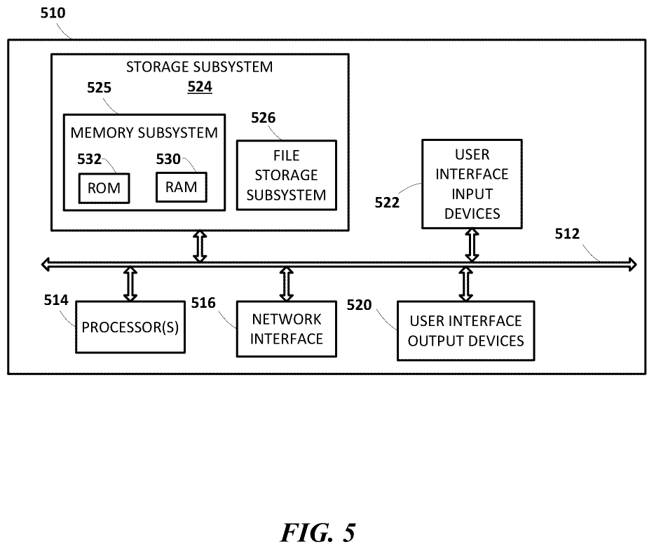

Turning now to FIG. 5, a block diagram of an example computing device 510 that may optionally be utilized to perform one or more aspects of techniques described herein is depicted. In some implementations, one or more of a client device, cloud-based LLM-based assistant component(s), and/or other component(s) may comprise one or more components of the example computing device 510.

Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the methods disclosed herein, as well as to implement various components depicted in FIG. 1.

These software modules are generally executed by processor 514 alone or in combination with other processors. Memory 525 used in the storage subsystem 524 can include a number of memories including a main random access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem 512 may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

Some other implementations disclosed herein recognize that training a generative model can require a significant quantity (e.g., millions) of training instances. Due to the significant quantity of training instances needed, many training instances will lack input and/or output properties that are desired when the generative model is deployed for utilization. For example, some training instance outputs for an LLM can be undesirably grammatically incorrect, undesirably too concise, undesirably too robust, etc. Also, for example, some training instance inputs for an LLM can lack desired contextual data such as user attribute(s) associated with the input, conversational history associated with the input, etc. As a result of many of the LLM training instances lacking desired input and/or output properties, the LLM will, after training and when deployed, generate many instances of output that likewise lack the desired output properties.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more transitory or non-transitory computer readable storage media storing computer instructions executable by one or more processors to perform any of the aforementioned methods. Some implementations also include a computer program product including instructions executable by one or more processors to perform any of the aforementioned methods.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, and/or method described herein. In addition, any combination of two or more such features, systems, and/or methods, if such features, systems, and/or methods are not mutually inconsistent, is included within the scope of the present disclosure.

What is claimed is:

1. A method implemented using one or more processors, the method comprising:
generating a plurality of training instances, wherein generating the plurality of training instances comprises:
generating a first training instance that includes:
a first training instance input, the first training instance input including: a first user input, first side information that provides information to formulate a response to the first user input, and a multi-part instruction, and
a first ground truth response to the first user query, the first ground truth response being derived from the first side information, and
generating a second training instance that includes:
a second training instance input, the second training instance input including: a second user input that is different from the first user input, second side information that provides no information to formulate a response to the second user input, and the multi-part instruction, and
a second ground truth response to the second user query; and
fine tuning a generative model using the plurality of training instances.

2. The method of claim 1, wherein the multi-part instruction includes a first description that instructs to utilize side information and a second description that instructs to only use inherent knowledge to respond when the side information contains no information for responding.

3. The method of claim 1, wherein the first user input includes a first user query, and wherein the first side information includes a first set of search results responsive to the first user query.

4. The method of claim 3, wherein the first set of search results are identified based on the first set of search results being responsive to a first entity in the first user query.

5. The method of claim 4, wherein the second user input includes a second user query, and wherein the second side information includes a second set of search results responsive to the second user query.

6. The method of claim 5, wherein the second set of search results are identified based on the second set of search results being responsive to a second entity in the second user query.

7. The method of claim 6, the first entity is the same as the second entity.

8. The method of claim 1, wherein fine tuning the generative model using the plurality of training instances comprises:
processing the first training instance input as input, using the generative model, to generate first model output from which a first response is determined,
comparing the first response with the first ground truth response, and
fine tuning the generative model based on comparing the first response with the first ground truth response.

9. The method of claim 1, wherein fine tuning the generative model using the plurality of training instances comprises:
processing the second training instance input as input, using the generative model, to generate second model output from which a second response is determined,
comparing the second response with the second ground truth response, and
fine tuning the generative model based on comparing the second response with the second ground truth response.

10. The method of claim 1, wherein the first ground truth response is generated based on processing a first prompt using an LLM, the first prompt including the first user input, the first side information, and a first instruction to respond to the first user input.

11. The method of claim 10, wherein the second ground truth response is generated based on processing a second prompt using the LLM, the second prompt including the second user input and a second instruction to respond to the second user input.

12. A method implemented using one or more processors, the method comprising:
generating a plurality of training instances, wherein generating the plurality of training instances comprises:
generating a first training instance that includes:
a first training instance input, the first training instance input including: a first user query, a first set of search results that provide information to formulate a response to the first user input, and a multi-part instruction, and
a first ground truth response to the first user query, the first ground truth response being derived from the first set of search results, and
generating a second training instance that includes:
a second training instance input, the second training instance input including: a second user input that is different from the first user input, a second set of search results that provide no information to formulate a response to the second user input, and the multi-part instruction, and
a second ground truth response to the second user query; and
fine tuning a generative model using the plurality of training instances.

13. The method of claim 12, wherein the multi-part instruction includes a first description that instructs to utilize side information and a second description that instructs to only use inherent knowledge to respond when the side information contains no information for responding.

14. The method of claim 12, wherein fine tuning the generative model using the plurality of training instances comprises:
processing the first training instance input as input, using the generative model, to generate first model output from which a first response is determined,
comparing the first response with the first ground truth response, and
fine tuning the generative model based on comparing the first response with the first ground truth response.

15. The method of claim 12, wherein fine tuning the generative model using the plurality of training instances comprises:
processing the second training instance input as input, using the generative model, to generate second model output from which a second response is determined,
comparing the second response with the second ground truth response, and
fine tuning the generative model based on comparing the second response with the second ground truth response.

16. A method implemented using one or more processors, the method comprising:
receiving, via a client device, a user input;
generating an input prompt based on the user input, the input prompt including the user input, one or more search results responsive to the user input, and a multi-part instruction;
processing the input prompt, using a fine-tuned generative model, to generate a model output from which a response to the user input is derived; and
causing the response to be rendered at an output device of the client device,
wherein the fine-tuned generative model is acquired based on fine tuning a pre-trained generative model using a plurality of training instance,
wherein the plurality of training instances include a first training instance that includes:
a first training instance input, the first training instance input including: a first user input, a first set of search results that provide information to formulate a response to the first user input, and the multi-part instruction, and
a first ground truth response to the first user query, the first ground truth response being derived from the first side information.

17. The method of claim 16, wherein the plurality of training instances include a second training instance that includes:
a second training instance input, the second training instance input including: a second user input that is different from the first user input, a second set of search results that provide no information to formulate a response to the second user input, and the multi-part instruction, and
a second ground truth response to the second user query.

18. The method of claim 16, wherein the multi-part instruction includes a first description that instructs to utilize search results and a second description that instructs to only use inherent knowledge to respond when the search results contain no information for responding.

19. The method of claim 16, wherein the second set of search results are the same as the first set of search results.

20. The method of claim 16, wherein the first user query identifies a first entity, and wherein the first set of search results are identified based on the first set of search results being responsive to the first entity in the first user query.
